(19) United States
(12) Patent Application Publication
(10) Pub. No.: US 2025/0117598 A1
(43) Pub. Date: Apr. 10, 2025

(54) Persona Knowledge-Aligned Prompt Tuning Method for Online Debate

(71) Applicant: The Hong Kong University of Science and Technology, Hong Kong (CN)

(72) Inventors: Chun Kit CHAN, Hong Kong (CN); Yangqiu SONG, Hong Kong (CN)

(21) Appl. No.: 18/810,567

(22) Filed: Aug. 21, 2024

Related U.S. Application Data
(60) Provisional application No. 63/588,294, filed on Oct. 6, 2023.

(51) Int. Cl. G06F 40/40; G06F 40/35

(52) U.S. Cl. CPC G06F 40/40; G06F 40/35

(57) ABSTRACT

A method and a system for automatic evaluation of online debate arguments are provided. The method includes: defining multiple persona knowledge dimensions; tailor-making a prompt template according to the defined persona knowledge dimensions to generate a persona knowledge eliciting prompt; inputting the persona knowledge eliciting prompt to a pretrained language model to elicit persona knowledge; associating the elicited persona knowledge and the context and argument in the prompt to construct a knowledge-aligned prompt; and utilizing the knowledge-aligned prompt to fine-tune a debate evaluation model to evaluate persuasiveness/impact of the online debate arguments. The present invention can be applied to digital platforms equipped with tools to facilitate virtual discussions, incorporating features such as real-time feedback, interactive interfaces, and enhanced accessibility options to improve the overall debate experience, expand the range of platform participants, and thus make debates easier to understand and more attractive.

### CROSS-REFERENCE TO RELATED APPLICATIONS

The present application claims priority from the U.S. Provisional Patent Application No. 63/588,294 filed Jun. 10, 2023, and the disclosure of which is incorporated herein by reference in its entirety.

### FIELD OF THE INVENTION

The present invention generally relates to a prompt tuning technology. More specifically the present invention relates to utilizing a persona knowledge-aligned framework in prompt tuning a debate evaluation model for automatic evaluation of online debate.

### BACKGROUND OF THE INVENTION

Debate is a process of exchanging viewpoints or convincing others on a particular issue. Recent research has provided empirical evidence that the persuasiveness of an argument is determined not only by language usage but also by communicators' characteristics. Researchers have paid much attention to the aspects of languages, such as linguistic features and discourse structures, but combining it with psychology has not been explored due to the difficulty and complexity.

We have observed the impressive simulation of an open world by ChatGPT, indicating a giant pre-trained language model may function as an individual to provide personae and exert unique influences based on diverse background knowledge.

In the field of Natural Language Processing (NLP) and Computational Argumentation, there is a burgeoning research interest in studies to develop computational methods that can automatically assess the qualitative characteristics of arguments. The impact and persuasiveness of the argument are crucial and pivotal qualitative characteristics, and substantial research have been conducted to develop computing methodologies for identifying the impact and the persuasiveness of a natural language argument in public debate forums. But estimating the impact or persuasiveness of an argument covering various topics requires more extensive knowledge than merely comprehending the semantic meaning of a language-based argument in a conversation. With the impressive simulation of an open world by ChatGPT, indicating a giant pre-trained language model may function as an individual to provide personae and exert unique influences based on diverse background knowledge.

The study of computational argumentation has recently attracted more attention, which uses corpora collected from web argumentation sources like the Change My View (CMV) sub-forum of Reddit to assess the qualitative impact of arguments. There are many literature studies on the importance and efficacy of various aspects in determining the persuasiveness, including surface textual, social interaction, and argumentation-related features, the characteristics of the source and audience, the sequence ordering of argument, and style feature aspects, were studied and investigated. Apart from the aforementioned features, the pragmatics and discourse context also adopted to in the analysis of arguments. They conducted experiments to demonstrate that the historical arguments are beneficial for the model performance to some extent. Lastly, there are some studies on how the context and dynamic progress of argumentative conversation affect comparative persuasiveness in the debate process.

Traditional works in argument assessment tasks have studied various aspects of knowledge. Among them, the impact and persuasiveness of arguments are inextricably linked not only to the linguistic attributes of the language but also to the traits of the communicators, including the source (speakers), the prior beliefs, argument structure, and the influence of discourse contexts. However, previous works have not well explored the analysis from psychology in a computational manner, except by annotations of human subjects. Computational studies for personae mainly come from the dialogue area and highlight the significance of personality information in dialogues. Research in social psychology has identified the factors of argument persuasiveness, one of which is the audience.

To be specific, throughout history, debates have been a cornerstone of human communication and decision-making, serving as a platform for individuals and groups to present their ideas, argue their positions, and persuade others. The art of debate is critical in various fields such as politics, education, law, and everyday decision-making.

Recent research has provided empirical evidence that the persuasiveness of an argument is determined not only by language usage but also by communicators' characteristics. These characteristics include factors such as the speaker's tone, body language, and perceived credibility, which can significantly influence the outcome of a debate. This understanding highlights the complexity of effective communication and the multifaceted nature of persuasion.

Researchers have paid much attention to the aspects of languages, such as linguistic features and discourse structures, but combining it with psychology has not been explored due to the difficulty and complexity. Integrating psychological principles into the study of debate can offer deeper insights into how arguments can be more effectively structured and delivered to achieve the desired persuasive outcomes.

In the field of Natural Language Processing (NLP) and Computational Argumentation, there is a growing research interest in developing computational methods to automatically assess the qualitative characteristics of arguments. These methods aim to evaluate arguments based on various qualitative factors, enhancing the ability to analyze and improve the persuasiveness of arguments through technological means. The impact and persuasiveness of arguments are crucial and pivotal qualitative characteristics, and substantial research has been conducted to develop computational methodologies for identifying the impact and persuasiveness of natural language arguments in public debate forums. However, estimating the impact or persuasiveness of an argument covering various topics requires more extensive knowledge than merely comprehending the semantic meaning of a language-based argument in a conversation.

With the impressive simulation of an open world by ChatGPT, a giant pre-trained language model may function as an individual to provide personae and exert unique influences based on diverse background knowledge. This indicates the potential for leveraging such advanced language models to enhance the quality and effectiveness of debates.

The study of computational argumentation has recently attracted more attention, using corpora collected from web argumentation sources like the CMV (Change My View) sub-forum of Reddit to assess the qualitative impact of arguments. This approach helps in understanding how arguments can be evaluated and improved based on real-world data from online debates.

There are many literature studies on the importance and efficacy of various aspects in determining persuasiveness. These aspects include surface textual features, social interaction, argumentation-related features, the characteristics of the source and audience, the sequence ordering of arguments, and style features. These studies investigate how each of these elements contributes to the overall persuasiveness of arguments. Apart from the aforementioned features, pragmatics and discourse context are also adopted in the analysis of arguments. Experiments have demonstrated that historical arguments are beneficial for model performance to some extent.

Lastly, there are studies on how the context and dynamic progress of argumentative conversation affect comparative persuasiveness in the debate process. These studies explore how the evolving nature of a conversation and the contextual factors influence the effectiveness of arguments in persuading audiences.

### SUMMARY OF THE INVENTION

The present invention aligns the persona knowledge into pre-trained language models via prompt tuning on the online debate task.

The present invention design a framework to elicit the persona knowledge from a large language model to benefit the online debate task.

The present invention is the first work to explore the role of persona knowledge for the online debate which leverages the emergency ability of Large Language Model (LLM), and injects such psychological information into smaller language models via prompt tuning to classify the argument's impact/persuasiveness.

The present invention addresses this need by introducing a novel approach that leverages state-of-the-art technology to improve the process of debating, making it more accessible, engaging, and impactful.

The present invention also provides the framework to distillate the persona knowledge from LLM to benefit the smaller model on the online debate task.

The present invention has observed the impressive simulation of an open world by LLM, indicating a giant pre-trained language model may function as an individual to provide personae and exert unique influences based on diverse background knowledge. Therefore, we propose a persona knowledge-aligned framework for argument quality assessment tasks from the psychology side. This is the first work that leverages the emergence of LLM and injects such psychological information into smaller language models via prompt tuning.

In some embodiments of the present invention, a novel approach is introduced to improve the process of debating by leveraging state-of-the-art technology and integrating psychological principles. This invention aims to make debates more accessible, engaging, and impactful through key components such as a persona knowledge-aligned framework, the use of LLM for prompt tuning, and digital tools for virtual discussions. The integration of psychological principles with linguistic features and discourse structures addresses a gap in the current research and practice of debate.

In some embodiments of the present invention, a persona knowledge-aligned framework is provided for argument quality assessment tasks from the psychology side. This is the first work that leverages the emergence of LLM and injects such psychological information into smaller language models via prompt tuning.

In one aspect of the embodiments of the present invention, a method for automatic evaluation of online debate arguments is provided. The method includes: defining multiple persona knowledge dimensions: tailoring a prompt template according to the defined persona knowledge dimensions to generate a persona knowledge eliciting prompt, wherein the persona knowledge eliciting prompt includes instruction, in-context demonstration, context and argument: inputting the persona knowledge eliciting prompt to a pretrained language model to elicit persona knowledge; associating the elicited persona knowledge and the context and argument in the prompt to construct a knowledge-aligned prompt; and utilizing the knowledge-aligned prompt to fine-tune a debate evaluation model to evaluate persuasiveness/impact of the online debate arguments.

In some embodiments, the step of utilizing the knowledge-aligned prompt to fine-tune the debate evaluation model to evaluate persuasiveness/impact of the online debate arguments comprises: formulating a classification problem for the persuasiveness/influence of online debate arguments: utilizing the knowledge-aligned prompt to formulate the classification problem as a conditional generation task to generate a learnable continuous token: updating the learnable continuous token by backpropagation to generate an output token; and mapping the generated output token to a class label for the persuasiveness/influence of online debate arguments.

The prompt template includes a context and argument. The debating LLM model is generated from inputting the prompt templates to a neutral LLM model. The LLM model includes advanced Natural Language Processing (NLP) techniques.

The persona knowledge includes a context and argument that are different from a context and argument of the prompt templates.

A plurality of personae of the persona knowledge are corresponded to a plurality of personae of the prompt template.

In another aspect of the embodiments of the present invention, a system for automatic evaluation of online debate arguments is provided. The system includes at least one memory and at least one processor. The at least one memory is configured to store multiple predefined persona knowledge dimensions, a pretrained language model and a debate evaluation model. The at least one processor is configured to: tailor a prompt template according to the defined persona knowledge dimensions to generate a persona knowledge eliciting prompt, wherein the persona knowledge eliciting prompt includes instruction, in-context demonstration, context and argument; input the persona knowledge eliciting prompt to a pretrained language model to elicit persona knowledge: associate the elicited persona knowledge and the context and argument in the prompt to construct a knowledge-aligned prompt; and utilize the knowledge-aligned prompt to fine-tune a debate evaluation model to evaluate persuasiveness/impact of the online debate arguments.

In some embodiments, the at least one processor is further configured to: formulate a classification problem for the persuasiveness/influence of online debate arguments: utilize the knowledge-aligned prompt to formulate the classification problem as a conditional generation task to generate a learnable continuous token: update the learnable continuous token by backpropagation to generate an output token; and map the generated output token to a class label for the persuasiveness/influence of online debate arguments.

A prompt template can be tailor in the module through the digital platform, and the component elicit a persona knowledge from a debating LLM model.

The prompt template includes a context and argument, and the debating LLM model is generated from inputting the prompt template to a neutral LLM model, which includes advanced Natural Language Processing (NLP) techniques.

The personal knowledge includes a context and argument that are different from a context and argument of the prompt templates.

A plurality of personae of the persona knowledge are corresponded to a plurality of personae of the prompt template.

In an embodiment of the present invention, the persona knowledge includes a personal stance. The personal stance describes the stance of a persona regarding the fiven argument and context.

In an embodiment of the present invention, the person knowledge includes a personal argument. The persona argument presents argument that supports the persona stance of the persona knowledge.

In an embodiment of the present invention, the persona knowledge includes a persona character, and the persona character describes intrinsic character traits that a persona exhibited.

In an embodiment of the present invention, the persona knowledge includes a persona intent, and the persona intent outlines the external action or outcome that the corresponded persona intends to achieve or accomplish in the forthcoming period.

In an embodiment of the present invention, the method further includes:
scoring relevance about the persona knowledge.

In an embodiment of the present invention, the method further includes:
scoring fluency about the persona knowledge.

In an embodiment of the present invention, the method further includes:
scoring consistency about the persona knowledge.

In an embodiment of the present invention, the method further includes:
scoring plausibility about the persona knowledge.

In an embodiment of the present invention, the method further includes:
scoring usefulness about the persona knowledge.

In an embodiment of the present invention, the method further includes:
scoring harmfulness about the persona knowledge.

In an embodiment of the present invention, the method further includes:
incorporating psychological principles into the structure and delivery of arguments:
utilizing a persona knowledge-aligned framework for argument quality assessment tasks from a psychological perspective:
injecting psychological information into smaller language models via prompt tuning; and integrating linguistic features and discourse structures with psychological insights.

In an embodiment of the present invention, the psychological principles include factors such as speaker tone, body language, and perceived credibility.

### BRIEF DESCRIPTION OF DRAWINGS

Embodiments of the invention are described in more details hereinafter with reference to the drawings, in which:

FIG. 1 illustrates personae knowledge elicited from a LLM by utilizing a tailor-made prompt temple in accordance with an embodiment of the present invention;

FIG. 2 illustrates a personae knowledge-aligned prompt framework for automatic evaluation of online debate in accordance with an embodiment of the present invention:

FIG. 3 illustrates an evaluation of five aspects of person knowledge of in accordance with an embodiment of the present invention

FIG. 4 is a tailored prompt template for eliciting persona knowledge from a LLM in accordance with an embodiment of the present invention:

FIG. 5 illustrate multiple PersonalPrompt Template during a template searching in accordance with an embodiment of the present invention; and

FIG. 6 illustrates personae knowledge elicited from another LLM by utilizing a tailor-made prompt temple in accordance with another embodiment of the present invention.

FIGS. 7A and 7B illustrate a flowchart for a method for automatic evaluation of online debate arguments in accordance with an embodiment of the present invention.

### DETAILED DESCRIPTION OF THE INVENTION

In the following description, method and system for automatic evaluation of online debate arguments and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention design a framework to elicit the persona knowledge from a large language model (LLM, i.e., ChatGPT) to benefit the online debate task.

The present invention has utilized the impressive simulation of an open world by LLM, indicating a giant pre-trained language model may function as an individual to provide personae and exert unique influences based on diverse background knowledge. Therefore, we propose a persona knowledge-aligned framework for argument quality assessment tasks from the psychology side. This is the first work that leverages the emergence of LLM and injects such psychological information into smaller language models via prompt tuning.

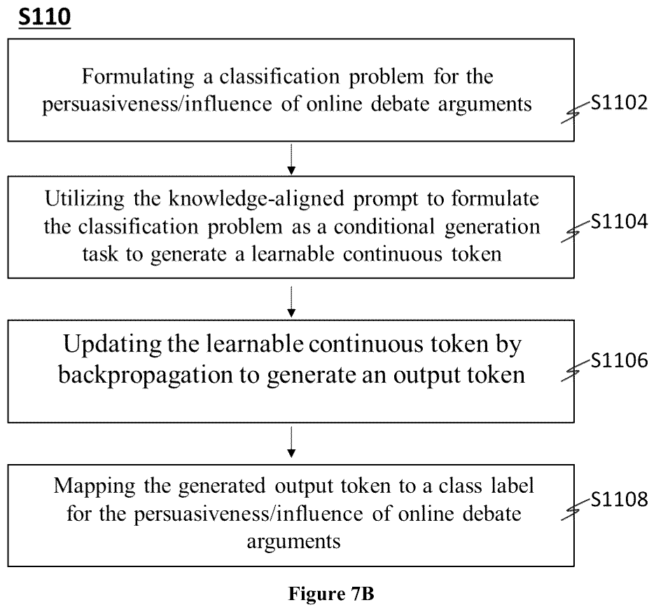

In accordance with one aspect of the present invention, a method S100 for automatic evaluation of online debate arguments is provided. Referring to FIG. 7A, the method S100 includes the following steps: S102: defining multiple persona knowledge dimensions: S104: tailor-making a prompt template according to the defined persona knowledge dimensions to generate a persona knowledge eliciting prompt: S106: inputting the persona knowledge eliciting prompt to a pretrained language model to elicit persona knowledge: S108: associating the elicited persona knowledge and the context and argument in the prompt to construct a knowledge-aligned prompt; and S110; utilizing the knowledge-aligned prompt to fine-tune a debate evaluation model to evaluate persuasiveness/impact of the online debate arguments.

Referring to FIG. 7B, in some embodiments, the step S110 comprises: S1102: formulating a classification problem for the persuasiveness/influence of online debate arguments: S1104: utilizing the knowledge-aligned prompt to formulate the classification problem as a conditional generation task to generate a learnable continuous token: S1106: updating the learnable continuous token by backpropagation to generate an output token; and S1108: mapping the generated output token to a class label for the persuasiveness/influence of online debate arguments.

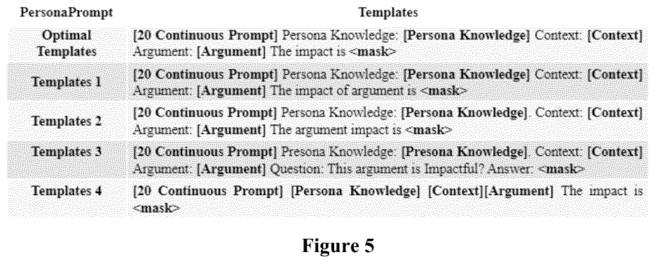

Referring to FIG. 4, the prompt template may be tailor-made such that the persona knowledge eliciting prompt includes a context and argument. The context may related to a topic of a debate, and it may include backgrounds of a resolution or proposition of the debates, and the argument may include the resolution or proposition. In some other embodiments, the prompt template may be tailor-made such that the persona knowledge eliciting prompt further includes an instruction, and an in-context demonstration.

The instruction recites a condition which involves an argument, and define the response we need from a LLM model, which is generated from this prompt template.

The in-context demonstration recites a context, an argument, and a plurality of character paragraphs. Every character paragraph for each persona includes the persona's stance about the context and argument, its argument about the context and argument, as well as its characters and intent.

After tailor-making the prompt template, the method of this embodiment elicits a persona knowledge from the LLM model.

The LLM model includes advanced NLP techniques. For example, the LLM model can be GPT 3.5, GPT 4, or GPT 40.

In accordance with another aspect of the present invention, a system for automatic evaluation of online debate arguments is also provided. The system includes: a digital platform that facilitates virtual discussions and participant engagement: a module that incorporates psychological principles into the structure and delivery of arguments; and a component that utilizes a persona knowledge-aligned framework for argument quality assessment tasks from a psychological perspective. The prompt template can be tailor-made in the module through the digital platform, and the component elicit persona knowledge from a LLM model. In other words, the system can execute the method S100 above, so as to perform automatic evaluation of online debate arguments.

The digital platform can include keyboard, mouse, touch pad, touch screen, or any other suitable input device. The module can include memory and processor (e.g. a central processing unit (CPU)). The component can include a graphic processing unit (GPU).

In some embodiments, the component can include GPU that is specialized in accelerating artificial intelligence (AI), high performance computing (HPC), data science, and graphics. For example, in some embodiments, the component can include at least two NVIDIA V100 Tensor Core GPUs with 32 GB configuration, and huge amount of computing resources can be trained in a few days, and a debating simulation can be applicable.

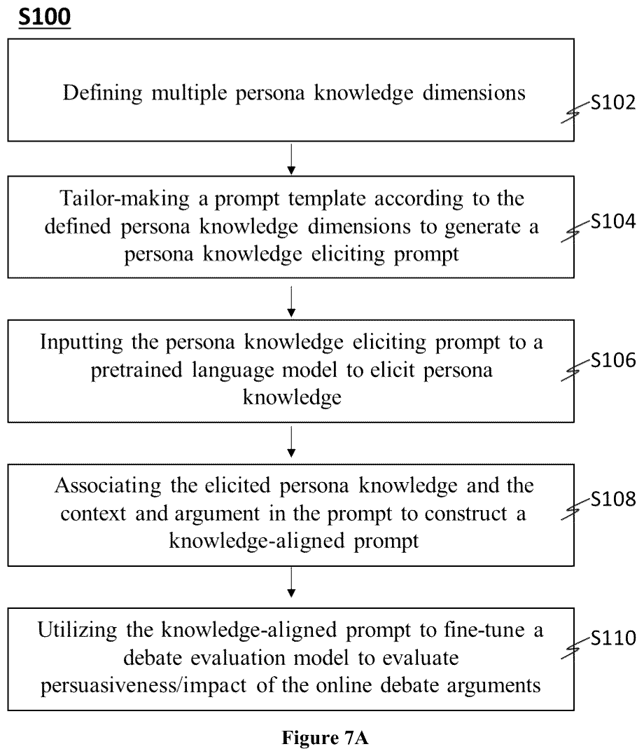

In an embodiment of the present invention, Persona Knowledge have multiple dimensions. To construct efficient and task-specific representations of persona knowledge on the online debate argument task, we tailor-make a specific prompt template to elicit multidimensional personae knowledge from the LLM model. FIG. 6 illustrate an exemplary persona knowledge elicited from by a LLM model, including Persona Stance, Persona Argument, Persona Characters, and Persona Intent. We meticulously design four dimensions for each persona knowledge instance as follows:

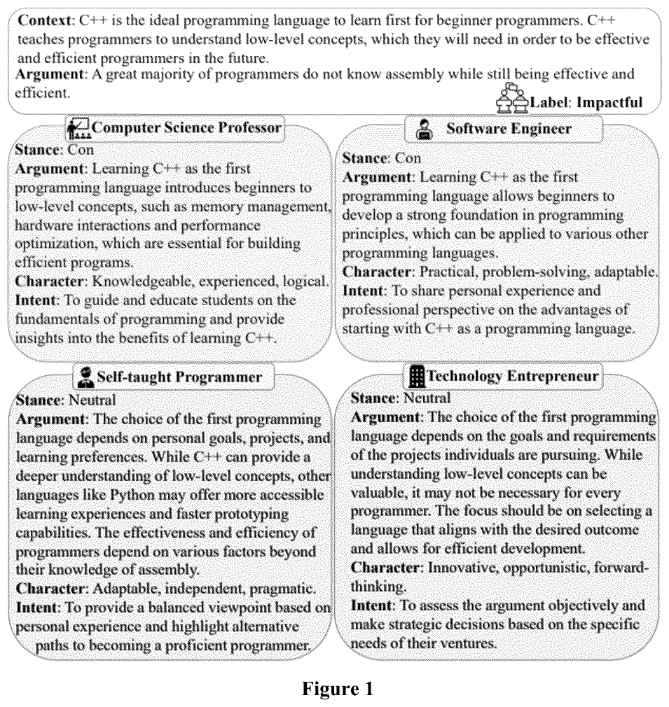

Persona Stance: this dimension describes the stance of a persona (i.e., Con, Pro, or Neutral) regarding the given argument and context. For example, FIG. 1 demonstrates a software engineer persona holding a Con stance on the given data.

Persona stance provides significant benefits by enhancing the effectiveness and persuasiveness of arguments in debates and discussions. By aligning arguments with the psychological profiles and characteristics of the speakers, persona stance allows for a more tailored and impactful communication strategy. By considering factors such as the speaker's tone, body language, credibility, and background knowledge, arguments can be presented in a way that resonates more deeply with the audience. This personalized approach not only improves the clarity and delivery of the message but also increases the likelihood of persuading the audience. Furthermore, persona stance facilitates a better understanding of the audience's perceptions and reactions, allowing speakers to adapt their arguments dynamically in real-time, leading to more engaging and productive interactions. Overall, the integration of persona stance into argumentation processes significantly elevates the quality and effectiveness of communication, making it a powerful tool in various fields such as politics, education, and law.

Persona Argument: This dimension presents a persona argument that supports his/her stance, utilizing his/her own background knowledge.

Persona argument provides substantial benefits by tailoring arguments to align with the individual characteristics and psychological profiles of both the speaker and the audience. This personalized approach considers factors such as tone, body language, perceived credibility, and specific background knowledge, making the argument more relatable and persuasive. By leveraging persona argument, speakers can enhance their connection with the audience, leading to increased engagement and trust. This method allows for dynamic adaptation of arguments in real-time, ensuring that the delivery remains impactful and relevant throughout the discussion. Moreover, persona argument facilitates a deeper understanding of the audience's responses, enabling more strategic and effective communication. This approach is particularly beneficial in fields such as marketing, education, and public speaking, where the ability to influence and persuade is crucial. Overall, persona argument significantly elevates the quality of discourse by making it more focused, effective, and engaging.

Persona Characters: This dimension describes intrinsic character traits that a persona is likely to exhibit. For instance, FIG. 1 shows that a computer science professor is likely to possess traits such as knowledgeability and logical thinking.

Persona characters provide significant benefits by allowing for the creation of tailored and relatable communication strategies in various contexts. These characters, developed based on detailed psychological profiles and background information, enable speakers to craft arguments and messages that resonate deeply with their target audience. By embodying specific traits, such as tone, body language, and credibility, persona characters help establish a strong connection with the audience, enhancing engagement and trust. This personalized approach ensures that the content is not only more persuasive but also more memorable. In marketing, education, and customer service, persona characters can make interactions more dynamic and effective by addressing the unique needs and preferences of different audience segments. Additionally, they enable more precise and impactful storytelling, which is crucial in capturing and maintaining audience attention. Overall, persona characters significantly improve the effectiveness of communication by making it more relatable, engaging, and targeted.

Persona Intent: This dimension outlines the external action or outcome that a persona intends to achieve or accomplish in the forthcoming period. For example, one possible intent of the computer science professor is “to guide and educate students on the fundamentals of programming and provide insights into the benefits of learning C++”.

Persona intent provides significant benefits by ensuring that communication is purpose-driven and aligned with the speaker's and audience's objectives. By clearly defining the intent behind each persona, speakers can craft messages that are more focused, persuasive, and relevant to their target audience. This approach enhances the clarity and impact of the communication, as it takes into account the specific goals, motivations, and desired outcomes of both the speaker and the listener. Persona intent helps in creating arguments that are not only logically sound but also emotionally compelling, increasing the likelihood of achieving the intended effect, whether it is to inform, persuade, or engage. In marketing, education, and public relations, persona intent ensures that messages are strategically designed to meet the audience's needs and expectations, leading to more effective interactions and stronger connections. Overall, persona intent adds depth and direction to communication efforts, making them more impactful and goal-oriented.

FIGS. 1 and 6 illustrate the persona knowledge elicited from language models ChatGPT-3.5 and ChatGPT-4 respectively. Each persona knowledge comprises persona instance, persona argument, persona character and persona intent. To be specific, the persona knowledge in FIG. 1 is generated by GPT-3.5, and another persona knowledge in FIG. 6 is generated by GPT-4. Therefore, the specific prompt template can be adapted to most of the LLM models.

In some embodiments of the present invention, to enhance the quality, effectiveness, and usefulness of generated persona knowledge and to address potential hallucination issues in the generated content, each persona and the corresponding four dimensions of generated knowledge are scored in the following criteria:

Relevance: that determines whether the Roles, Argument, and Intent are relevant to the argument and context.

The item “Relevance” in debate evaluation offers significant benefits by ensuring that the content being assessed is directly pertinent to the topic, context, or user needs. By focusing on relevance, evaluators can determine how well the information or arguments align with the subject matter and the audience's interests, leading to more meaningful and impactful communication. This criterion helps in filtering out extraneous or off-topic content, ensuring that the discourse remains focused and valuable. In educational settings, relevance ensures that teaching materials and discussions are closely aligned with learning objectives, enhancing comprehension and retention. In marketing and customer service, it ensures that messages and solutions address the specific needs and concerns of the target audience, increasing satisfaction and engagement. Overall, incorporating relevance in debate evaluation improves the effectiveness and efficiency of communication by maintaining a clear and purposeful focus, making interactions more productive and satisfying.

Fluency: that assesses the fluency and understandability of the Roles, Argument, and Intent.

The dimension “Fluency” in debate evaluation provides significant benefits by ensuring that the content is easily understandable, well-structured, and grammatically correct. Evaluating fluency helps in identifying and eliminating language errors, awkward phrasing, and unclear expressions, which can hinder comprehension and reduce the overall impact of the message. In educational materials, marketing content, and customer communications, high fluency enhances readability and engagement, making the information more accessible to a wider audience. By prioritizing fluency, evaluators can ensure that the content flows smoothly, facilitating a better understanding and retention of the information presented.

Consistency: that evaluates whether the Intent and Argument are consistent with Stance.

The dimension “Consistency” in debate evaluation ensures that the content maintains a uniform tone, style, and message throughout. Consistency is crucial for building trust and credibility, as it prevents confusion and reinforces the intended message. In branding, educational materials, and professional documentation, consistency helps establish a cohesive narrative, making the information more reliable and professional. By evaluating consistency, content creators can avoid contradictions and discrepancies, ensuring that the audience receives a clear and coherent message that aligns with their expectations and the overall purpose of the communication.

Plausibility: that gauges the reasonability and plausibility of the Intent and Argument:

The item “Plausibility” in debate evaluation provides the benefit of ensuring that the content is believable and logically sound. Evaluating plausibility helps in verifying that the arguments, claims, and information presented are credible and based on evidence or logical reasoning. This is particularly important in academic writing, scientific research, and persuasive communication, where the validity of the content is crucial. By focusing on plausibility, evaluators can enhance the reliability and persuasiveness of the content, fostering trust and acceptance among the audience.

Usefulness: that measures whether the generation helps in determining the persuasiveness of the data argument:

The item “Usefulness” in debate evaluation ensures that the content provides practical value and meets the needs of the audience. Evaluating usefulness helps in determining whether the information or arguments presented are relevant, actionable, and beneficial to the target audience. In educational settings, customer support, and informational content, usefulness ensures that the audience gains valuable insights and solutions that address their specific concerns and interests. By prioritizing usefulness, evaluators can enhance the overall impact and effectiveness of the content, making it more likely to achieve its intended purpose.

Harmfulness: that estimates whether the generated knowledge includes harmful and toxic language or words.

The item “Harmfulness” in debate evaluation helps in identifying and mitigating any potential negative impacts of the content. Evaluating harmfulness involves checking for content that could be offensive, misleading, or damaging to individuals or groups. This is critical in maintaining ethical standards and social responsibility in communication. By focusing on harmfulness, evaluators can ensure that the content is respectful, accurate, and safe for consumption, thereby protecting the well-being of the audience and preventing negative repercussions. This evaluation fosters a more positive and responsible approach to content creation and dissemination.

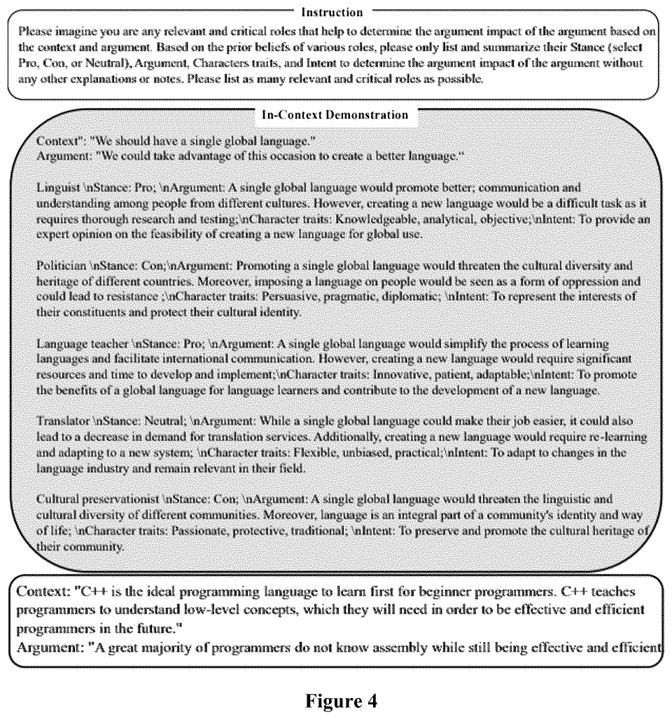

For example, referring to FIG. 3, an evaluation of the persona knowledge generated through ChatGPT is presented. The harmfulness aspect in these persona knowledges is zero. It may attribute to the ChatGPT fine-tuned with reinforcement learning from human feedback approach, which prevents ChatGPT from generating harmful language without deliberate attacks.

In another embodiment, the debate evaluation is executed through another evaluating LLM model. By inputting the persona knowledge, the LLM model can provide an evaluation report including the scores corresponded to the dimension above.

Some embodiments of the present invention have demonstrated that pre-trained language models (PLMs) of the embodiment can effectively understand label semantics and task objectives through prompt learning. We utilize indicators to separate the “context” and “argument” and instruct the models to predict either the winner of the debate or the potential impact level of an argument.

Additionally, in these embodiments, we incorporate persona knowledge generated by ChatGPT as the “background” preceding the context, which provides a broader and more comprehensive perspective on the debate process.

To ensure the generation of high-quality personae knowledge, we provide not only the data (i.e., the context and argument) and carefully crafted instructions but also in-context demonstrations to prompt ChatGPT for generating the four-dimensional knowledge in a specific format with the persona knowledge eliciting prompt (I).

Instead of fine-tuning the entire PLM architecture, we employ a more efficient approach known as soft prompt tuning in these embodiments. We introduce learnable “continuous tokens” at the beginning of the input, allowing them to be updated through backpropagation. We formulate classification problems as conditional generation tasks, utilizing the persona knowledge-aligned prompt (II), where the generated tokens are subsequently mapped to class labels.

For example. PresonaPrompt is prompt tuning upon Flan-T5, which uses instructions to tune the T5 model, and we also validate our method over two model scales, including T5-base and T5-large by setting the learnable prompt length as 20.

For argument impact classification task, the training was implemented using cross-entropy loss with 30,000 training steps, which selects the debate evaluation model that yields the best performance on the validation set. We adopt an Adafactor optimizer with various learning rate ranges for different dataset settings. The batch size and maximum input sequence are 4 and 512, respectively. The maximum generates sequence length of the encoder is 10. Our debate evaluation model is conducted on two 32 GB NVIDIA V100 GPUs. The running time for T5-base is around 8 hours, while T5-large is about 22 hours. The frozen pre-trained T5 model download from HuggingFace, and our model inheritance and modification from OpenPrompt.

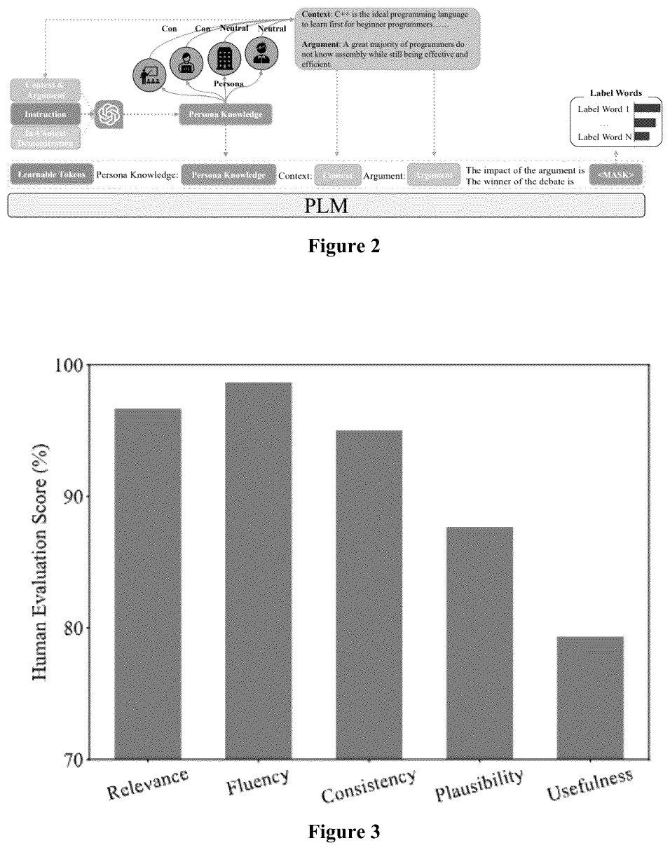

In other words, Previous research on language modeling has demonstrated that PLMs can effectively understand label semantics and task objectives through prompt learning. As shown in FIG. 2, indicators separate the “context” and “argument” and instruct the models to predict either the winner of the debate or the potential impact level of an argument.

Additionally, persona knowledge generated by ChatGPT is the “background” preceding the context, which provides a broader and more comprehensive perspective on the debate process.

To ensure the generation of high-quality personae, we provide not only the data (i.e., the context and argument) and carefully crafted instructions but also in-context demonstrations (refer to FIG. 4) to prompt ChatGPT for generating the four-dimensional knowledge in a specific format with the persona knowledge eliciting prompt (I).

The PLM is processed with soft prompt tuning. In these embodiments, “continuous tokens” are included at the beginning of the input, allowing them to be updated through backpropagation. We formulate classification problems as conditional generation tasks, utilizing the persona knowledge-aligned prompt (II), where the generated tokens are subsequently mapped to class labels.

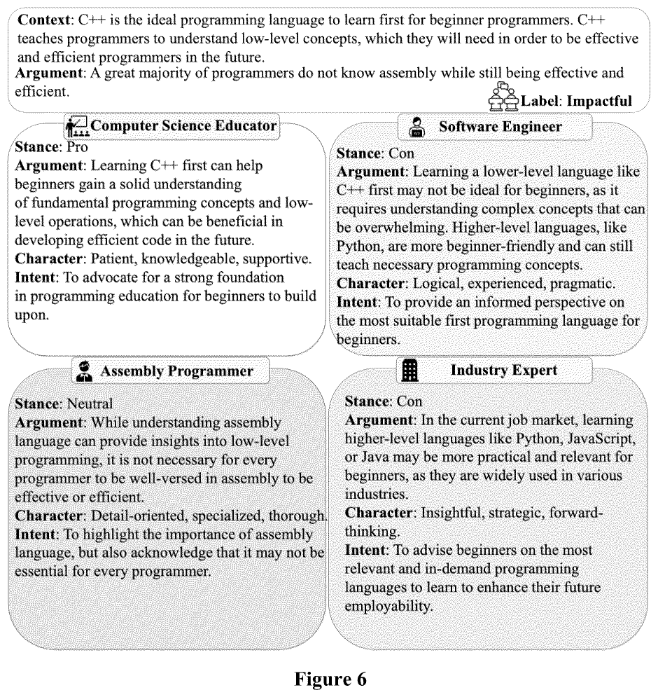

PresonaPrompt is prompt tuning upon Flan-T5, which uses instructions to tune the T5 model, and we also validate our method over two model scales, including T5-base and T5-large. We sets the learnable prompt length as 20. For argument impact classification task, the training was implemented using cross-entropy loss with 30,000 training steps, which selects the model that yields the best performance on the validation set. We adopt an Adafactor optimizer with various learning rate ranges for different dataset settings. The batch size and maximum input sequence are 4 and 512, respectively. The maximum generates sequence length of the encoder is 10. Our model is conducted on two 32 GB NVIDIA V100 GPUs. The running time for T5-base is around 8 hours, while T5-large is about 22 hours. The tailored prompt template is shown in FIG. 5. The frozen pre-trained T5 model download from HuggingFace, and our model inheritance and modification from OpenPrompt.

The present invention introduces a comprehensive method to enhance the process of debating by integrating advanced technology and psychological principles. The present invention can be applied to digital platforms equipped with tools to facilitate virtual discussions, incorporating features such as real-time feedback, interactive interfaces, and enhanced accessibility options to improve the overall debate experience, expand the range of platform participants, and thus make debates easier to understand and more attractive. The invention comprises the following detailed embodiments:

### Persona Knowledge-Aligned Framework:

Embodiment 1: In this embodiment of the present invention, a framework that aligns persona knowledge with the assessment of argument quality is present. This framework evaluates arguments based on psychological principles, considering factors such as the speaker's tone, body language, and perceived credibility. These elements are crucial in determining the persuasiveness of an argument.

### Leveraging ChatGPT and Prompt Tuning:

Embodiment 2: This embodiment of the present invention leverages the capabilities of ChatGPT, a large pre-trained language model, to enhance the persuasiveness of arguments. The process involves prompt tuning, where psychological information is injected into smaller language models, enabling them to produce more effective and convincing arguments.
Embodiment 3: An approach of this embodiment is novel in its integration of advanced language models with psychological principles, offering a unique method for improving argument quality.

### Digital Tools and Platforms:

Embodiment 4: This embodiment of the present invention utilizes digital platforms equipped with tools that facilitate virtual discussions. These platforms broaden the reach of participants, making debates more accessible and engaging.
Embodiment 5: In this embodiment, features such as real-time feedback, interactive interfaces, and enhanced accessibility options are incorporated to improve the overall debate experience.

### Integration of Psychological Principles:

Embodiment 6: By combining linguistic features and discourse structures with psychological insights, this embodiment addresses a gap in current debate research and practice. The integration of these elements offers deeper insights into effective argumentation.
Embodiment 7: Studies have shown that the integration of psychological principles with linguistic features can significantly improve the persuasiveness of arguments. This embodiment of the present invention leverages these findings to enhance debate quality.

### Assessment of Qualitative Characteristics:

Embodiment 8: This embodiment of the present invention includes methods to automatically assess the qualitative characteristics of arguments. These methods evaluate arguments based on various qualitative factors, enhancing the ability to analyze and improve their persuasiveness.
Embodiment 9: An approach of this embodiment of the present invention uses corpora collected from web argumentation sources, such as the CMV (Change My View) sub-forum of Reddit, to assess the qualitative impact of arguments. This real-world data provides valuable insights into effective argumentation.

### Consideration of Pragmatics and Discourse Context:

Embodiment 10: Apart from the aforementioned features, this embodiment of the present invention considers pragmatics and discourse context in the analysis of arguments. This comprehensive approach ensures that all relevant factors are taken into account in evaluating argument quality.
Embodiment 11: This embodiment of the present invention demonstrates that historical arguments are beneficial for model performance to some extent, highlighting the importance of considering past arguments in the evaluation process.

### Dynamic Progress and Contextual Influence:

Embodiment 12: This embodiment of the present invention explores how the context and dynamic progress of argumentative conversations affect comparative persuasiveness. Studies have shown that the evolving nature of a conversation and contextual factors significantly influence the effectiveness of arguments.
Embodiment 13: By incorporating these elements, this embodiment provides a holistic approach to improving debate quality, considering both static and dynamic aspects of argumentation. Additionally, this approach emphasizes the significance of adapting arguments in real-time to the flow of conversation and the immediate responses of interlocutors, thus enhancing the overall impact and persuasiveness.

### Advanced NLP Techniques and Integration:

Embodiment 14: This embodiment of the present invention utilizes advanced Natural Language Processing (NLP) techniques to integrate various aspects of argumentation, including linguistic features, psychological insights, and real-time interaction data. This integration enables a more comprehensive analysis and improvement of argument quality.
Embodiment 15: The use of NLP techniques also allows for the continuous adaptation and refinement of arguments based on feedback and interaction dynamics, ensuring that arguments remain relevant and persuasive throughout the debate process.

To validate the effectiveness of persona knowledge in debate tasks, in an embodiment, we conducted experiments on two tasks: argument impact classification in the Kialo dataset and argument persuasion prediction in the DDO dataset.

TABLE 1
The mean and standard deviation of the performance of different models on argument impact
classification. KNOWLEDGE indicates incorporating with the generated persona knowledge.

| Model | Precision | Recall | F1 |
|---|---|---|---|
| MAJORITY | 19.43 | 33.33 | 24.55 |
| SVM (Durmus et al., 2019) | 65.67 | 38.58 | 35.42 |
| BILSTM (Lis et al., 2021b) | 46.94 ± 1.08 | 46.64 ± 0.71 | 46.51 ± 1.11 |
| HAN-BILSTM (Liu et al., 2021b) | 51.93 ± 1.37 | 49.08 ± 1.52 | 50.00 ± 1.49 |
| BERT (DURMUS ET AL., 2019) | 57.19 ± 0.92 | 55.77 ± 1.05 | 55.98 ± 0.70 |
| DISCOC (Lin et al., 2021b) | 57.90 ± 0.70 | 59.41 ± 1.41 | 58.36 ± 0.52 |
| FINE-TUNING (TS-BASE) (Raffel et al., 2020) | 58.48 ± 1.04 | 59.57 ± 0.54 | 58.45 ± 0.69 |
| FINE-TUNING (TS-BASE) (KNOWLEDGE) (Raffel et al., 2020) | 60.37 ± 1.73 | 60.58 ± 0.21 | 60.10 ± 1.25 |
| FINE-TUNING (T5-LARGE) (Raffel et al., 2020) | 58.95 ± 0.81 | 63.42 ± 0.52 | 60.23 ± 0.23 |
| FINE-TUNING (TS-LARGE) (KNOWLEDGE) (Raffel et al., 2020) | 61.63 ± 1.04 | 66.56 ± 0.56 | 63.31 ± 0.68 |
| PREFIX-TUNING (TS-BASE) (Li and Liang, 2021) | 61.95 ± 2.03 | 57.69 ± 1.44 | 58.35 ± 1.24 |
| PREHX-TUNING (TS-BASE) (KNOWLEDGE) (Li and Liang, 2021) | 61.85 ± 1,43 | 60.96 ± 0.17 | 60.13 ± 0.22 |
| PRERX-TUNING (T5-LARGE) (Li and Liang, 2021) | 65.78 ± 0.95 | 63.28 ± 1.25 | 63.75 ± 1.01 |
| PREFIX-TUNING (TS-LARGE) (KNOWLEDGE) (Li and Liang, 2021) | 67.09 ± 1.53 | 65.07 ± 0.64 | 65.38 ± 0.71 |
| PROMPT-TUNING (T5-BASB) (Lester et al., 2021) | 61.05 ± 1.58 | 67.80 ± 0.76 | 58.61 ± 0.84 |
| PROMPT-TUNING (TS-BASE) (KNOWLEDGE) (Lester et al., 2021) | 60.52 ± 0.32 | 59.78 ± 0.62 | 59.58 ± 0.69 |
| PROMPT-TUNING (TS-LARGE) (Lester et al., 2021) | 63.48 ± 1.33 | 63.13 ± 0.78 | 63.10 ± 0.77 |
| PROMPT-TUNING (T5-LARGE) (KNOWLEDGE) (Lester et al., 2021) | 66.79 ± 1.03 | 64.46 ± 0.75 | 65.28 ± 0.46 |
| PERSONAPROMPT (T5-BASE) | 59.19 ± 0.57 | 60.20 ± 0.67 | 59.29 ± 0.67 |
| PERSONAPROMPT (TS-BASE) (KNOWLEDGE) | 64.35 ± 0.63 | 62.11 ± 0.36 | 62.81 ± 0.31 |
| PERSONAPROMPT (TS-LARGE) | 65.40 ± 0.54 | 64.26 ± 1.08 | 64.35 ± 0.51 |
| PERSONAPROMPT (TS-LARGE) (KNOWLEDGE) | 67.03 ± 1.24 | 67.09 ± 0.58 | 67.67 ± 0.54 |

TABLE 2
The performance of the models on the argument persuasion
prediction task, where the upper portions of baselines
are Logistic Regression (LR) models with the linguistic
feature, user information, and argument structure

| Model | Accuracy |
|---|---|
| MAJORITY | 62.62 |
| LINGUISTIC + USER LR | 67.41 |
| ARG-STRUCT LR | 69.52 |
| LINGUISTIC + ARG-STRUCT LR | 70.48 |
| LINGUISTIC + USER + ARG-STRUCT LR | 70.44 |
| BERT | 64.71 |
| BERT (KNOWLEDGE) | 66.09 |
| DISCOC | 64.48 |
| DISCOC (KNOWLEDGE) | 67.01 |
| FINE-TUNING (TS-BASE) | 70.15 |
| FINE-TUNING (TS-BASE) (KNOWLEDGE) | 72.87 |
| FINE-TUNING (T5-LARGE) | 71.95 |
| FINE-TUNING (TS-LARGE) (KNOWLEDGE) | 74.25 |
| PREFIX-TUNING (T5-BASE) | 68.62 |
| PREFIX-TUNING (T5-BASE) (KNOWLEDGE) | 71.26 |
| PREFIX-TUNING (TS-LARGE) | 70.69 |
| PREFIX-TUNING (TS-LARGE) (KNOWLEDGE) | 73.41 |
| PROMPT-TUNING (TS-BASE) | 68.01 |
| PROMPT-TUNING (T5-BASE) (KNOWLEDGE) | 71.61 |
| PROMPT-TUNING (T5-LARGE) | 71.26 |
| PROMPT-TUNING (T5-LARGE) (KNOWLEDGE) | 73,64 |
| PERSONAPROMPT (T5-BASE) | 71.38 |
| PERSONAPROMPT (T5-BASE) (KNOWLEDGE) | 73.45 |
| PERSONAPROMPT (TS-LARGE) | 73.56 |
| PERSONAPROMPT (TS-LARGE) (KNOWLEDGE) | 75.86 |

In these tables, Precision is a metric used to measure the accuracy of the persuasiveness predictions made by a model. It is calculated as the number of true positive results divided by the sum of true positive and false positive results. In simpler terms, precision tells us how many of the predicted positive outcomes were actually correct. A high precision indicates that the model has a low false positive rate, meaning it is good at avoiding incorrect persuasiveness predictions.

Recall, also known as sensitivity or true positive rate, measures the ability of a model to identify all positive instances within a dataset. It is calculated as the number of true positive results divided by the sum of true positive and false negative results. Recall tells us how many of the actual positive instances were correctly identified by the model. A high recall indicates that the model is good at detecting positive cases, even if it sometimes includes false positives.

The F1 score is a metric that combines both precision and recall into a single measure. It is the harmonic mean of precision and recall, providing a balance between the two. The F1 score is particularly useful when we need to find a balance between precision and recall, especially in cases where we want to ensure that neither false positives nor false negatives are excessively high. A high F1 score indicates that the model has a good balance between precision and recall.

Table 1 and Table 2 summarize the main results of the two online debate tasks, which include the argument impact classification task and argument persuasion task, from which we derive the following conclusions.

First, our method, i.e. PersonaPrompt, significantly outperforms all baselines in both two tasks and achieves state-of-the-art (SOTA) performance in the argument impact classification task. Specifically, our method (T5-base) outperforms previous SOTA DisCOC with at least 4.45% F1 score in the argument impact classification task.

Second, our model gains a considerable improvement of 4.36% F1 score and 3.30% accuracy over the fine-tuning of the T5-base (without persona knowledge) model in the Kialo dataset and DDO dataset. It demonstrates that our method effectively utilizes the persona knowledge, perceives this specific knowledge on the correlation of knowledge and the data argument and context, and finally enhances the ability of T5 to undertake this challenging task.

Third, all models fine-tuning or prompt-tuning with the knowledge exhibits a certain extent improvement over original tuning. Especially, PersonPrompt (T5-base) obtain a 3.51% F1 score gain in performance over original tuning without persona knowledge. It illustrates the effectiveness of the generated persona knowledge on the online debate quality assessment tasks.

The functional units and modules of the system in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A method for automatic evaluation of online debate arguments, comprising:
defining multiple persona knowledge dimensions;
tailor-making a prompt template according to the defined persona knowledge dimensions to generate a persona knowledge eliciting prompt, wherein the persona knowledge eliciting prompt includes instruction in-context demonstration, context and argument;
inputting the persona knowledge eliciting prompt to a prepared language model to elicit persona knowledge from the pretrained language model;
associating the elicited persona knowledge and the context and argument in the prompt to construct a knowledge-aligned prompt, and
utilizing the knowledge-aligned prompt to fine-tune a debate evaluation model to evaluate persuasiveness/impact of the online debate arguments.

2. The method of claim 1, wherein the persona knowledge includes a persona stance, and the persona stance describes the stance of a persona regarding the given argument and context.

3. The method of claim 2, wherein the persona knowledge includes a persona argument, and the persona argument presents argument that supports the persona stance of the persona knowledge.

4. The method of claim 1, wherein the persona knowledge includes a persona character, and the persona character describes intrinsic character traits that a persona exhibited.

5. The method of claim 1, wherein the persona knowledge includes a persona intent, and the persona intent outlines the external action or outcome that the corresponded persona intends to achieve or accomplish in the forthcoming period.

6. The method of claim 1 further includes: scoring relevance about the persona knowledge.

7. The method of claim 1 further includes: scoring fluency about the persona knowledge.

8. The method of claim 1 further includes: scoring consistency about the persona knowledge.

9. The method of claim 1 further includes: scoring plausibility about the persona knowledge.

10. The method of claim 1 further includes: scoring usefulness about the persona knowledge.

11. The method of claim 1 further includes: scoring harmfulness about the persona knowledge.

12. The method of claim 1 further comprising:
incorporating psychological principles into the structure and delivery of arguments:
utilizing a persona knowledge-aligned framework for argument quality assessment tasks from a psychological perspective:
injecting psychological information into smaller language models via prompt tuning; and
integrating linguistic features and discourse structures with psychological insights.

13. The method of claim 12, wherein the psychological principles include factors such as speaker tone, body language, and perceived credibility.

14. The method of claim 1, wherein the step of utilizing the knowledge-aligned prompt to fine-tune the debate evaluation model to evaluate persuasiveness/impact of the online debate arguments comprises,
formulating a classification problem for the persuasiveness/influence of online debate arguments;
utilizing the knowledge-aligned prompt to formulate the classification problem as a conditional generation task to generate a learnable continuous token;
updating the learnable continuous token by backpropagation to generate an output token; and
mapping the generated output token to a class label for the persuasiveness/influence of online debate arguments.

15. A system for automatic evaluation of online debate arguments, comprising at least one memory and at least one processor, wherein:
the at least one memory is configured to stop multiple predefined persona knowledge dimensions, a pretrained language model and a debate evaluation model; and
the at least one processor is configured to:
tailor-make a prompt template according to the defined persona knowledge dimensions to generate a persona knowledge eliciting prompt, wherein the persona knowledge eliciting prompt includes instruction, in-context demonstration, context and argument;
input the persona knowledge eliciting prompt to a pretrained language model to elicit persona knowledge from the pretrained language model;
associate the elicited persona knowledge and the context and argument in the prompt to construct a knowledge-aligned prompt, and
utilize the knowledge-aligned prompt to fine-tune a debate evaluation model to evaluate persuasiveness/impact of the online debate arguments.

16. The system of claim 15, wherein the persona knowledge includes a persona stance, and the persona stance describes the stance of a persona regarding the given argument and context.

17. The system of claim 16, wherein the persona knowledge includes a persona argument, and the persona argument presents argument that supports the persona stance of the persona knowledge.

18. The system of claim 15, wherein the persona knowledge includes a persona character, and the persona character describes intrinsic character traits that a persona exhibited.

19. The system of claim 15, wherein the persona knowledge includes a persona intent, and the persona intent outlines the external action or outcome that the corresponded persona intends to achieve or accomplish in the forthcoming period.

20. The system of claim 15, wherein the at least one processor is further configured to evaluate was the personal knowledge by scoring relevance about the persona knowledge.

21. The system of claim 15, wherein at least one processor is further configured to evaluate the personal knowledge by scoring fluency about the persona knowledge.

22. The system of claim 15, wherein at least one processor is further configured to evaluate the personal knowledge by scoring consistency about the persona knowledge.

23. The system of claim 15, wherein the at least one processor is further configured to evaluate the personal knowledge by scoring plausibility about the persona knowledge.

24. The system of claim 15, wherein the at least one processor is further configured to evaluate the personal knowledge by scoring usefulness about the persona knowledge.

25. The system of claim 15, wherein the at least one processor is further configured to evaluate the personal knowledge by scoring harmfulness about the persona knowledge.

26. The system of claim 15, wherein
the system incorporates psychological principles into the structure and delivery of arguments, and the system utilizes a persona knowledge-aligned framework for argument quality assessment tasks from a psychological perspective, and the system injects psychological information into smaller language models via prompt tuning, and
the system integrates linguistic features and discourse structures with psychological insights.

27. The system of claim 26, wherein the psychological principles include factors such as speaker tone, body language, and perceived credibility.

28. The system of claim 15, wherein the at least one processor is further configured to:
formulate a classification problem for the persuasiveness/influence of online debate arguments;
utilize the knowledge-aligned prompt to formulate the classification problem as a conditional generation task to generate a learnable continuous token;
update the learnable continuous token by backpropagation to generate an output token; and
map the generated output token to a class label for the persuasiveness/influence of online debate arguments.
